(19) United States
(12) Patent Application Publication
(10) Pub. No.: US 2026/0358746 A1
(43) Pub. Date: Nov. 12, 2026

(54) IMAGE FORMING SYSTEM

(71) Applicant: Konica Minolta, Inc., Tokyo (JP)

(72) Inventor: Shoichi NOMURA, Tokyo (JP)

(21) Appl. No.: 19/668,029

(22) Filed: May 5, 2026

(30) Foreign Application Priority Data
May 9, 2025 (JP) 2025-078717

(51) Int. Cl. G03G 15/00; H04N 1/00

(52) U.S. Cl. CPC G03G 15/703; G03G 15/6502; G03G 15/6552; G03G 15/6558; G03G 15/6573; H04N 1/00708; H04N 1/00737; G03G 2215/00556; G03G 2215/00734; G03G 2215/00759; H04N 2201/0081

(57) ABSTRACT

An image forming system includes an image former configured to form an image on a recording medium, a first reading device provided upstream of the image former in a conveyance direction of the recording medium and configured to read, with a first reader, the recording medium conveyed along a first conveyance route, and a second reading device provided downstream of the image former in the conveyance direction and configured to read, with a second reader, the recording medium conveyed along a second conveyance route. A first distance that is a distance between the first reader and a first restricting member that restricts a passable area for the recording medium at the first conveyance route is longer than a second distance that is a distance between the second reader and a second restricting member that restricts a passable area for the recording medium at the second conveyance route.

### CROSS REFERENCE TO RELATED APPLICATION

The present invention claims priority under 35 U.S.C. § 119 to Japanese Patent Application No. 2025-078717, filed on May 9, 2025, the entire contents of which being incorporated herein by reference.

### BACKGROUND OF THE INVENTION

### Technical Field

The present disclosure relates to an image forming system.

### Description of Related Art

Some image forming apparatuses include a reading section configured to read a recording medium conveyed along a conveyance route before image formation (e.g., Japanese Unexamined Patent Application Publication No. 2019-025721).

### SUMMARY OF THE INVENTION

In general, an image forming apparatus is designed such that recording media are stacked on a tray and fed one by one onto a conveyance route by a sheet feed roller or the like. However, depending on the type of recording medium, the state thereof, or the like, multi-feeding may occur in which recording media are unintentionally fed at once. When recording media that are conveyed in such a multi-fed state pass, on a conveyance route, between, for example, a reading section and a background member provided at a position facing the reading section, a passing-sheet jam may occur.

An object of the present disclosure is to provide an image forming system capable of suppressing occurrence of a jam caused by multi-fed recording media.

To achieve at least one of the abovementioned objects, according to an aspect of the present disclosure, an image forming system reflecting one aspect of the present disclosure includes:
an image former configured to form an image on a recording medium;
a first reading device provided upstream of the image former in a conveyance direction of the recording medium and configured to read, with a first reader, the recording medium conveyed along a first conveyance route; and
a second reading device provided downstream of the image former in the conveyance direction of the recording medium and configured to read, with a second reader, the recording medium conveyed along a second conveyance route,
wherein a first distance that is a distance between the first reader in the first reading device and a first restricting member that restricts a passable area for the recording medium at the first conveyance route is longer than a second distance that is a distance between the second reader in the second reading device and a second restricting member that restricts a passable area for the recording medium at the second conveyance route.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a diagram illustrating a schematic configuration of an image forming system according to the present embodiment;

FIG. 2 is a functional block diagram illustrating the control structure of the image forming system according to the present embodiment;

FIG. 3 is a diagram illustrating another example of the positions of a first reading section and a first opposing section;

FIG. 4 is a diagram illustrating a configuration of the first reading section and the first opposing section;

FIG. 5 is a diagram illustrating a configuration of a second reading section and a second opposing section;

FIG. 6 is a diagram illustrating a configuration of a first reading section and a first opposing section according to a first modification example; and

FIG. 7 is a diagram illustrating a configuration of a first reading section and a first opposing section according to a second modification example.

### DETAILED DESCRIPTION

Hereinafter, one or more embodiments of the present disclosure will be described with reference to the drawings. However, the scope of the invention is not limited to the disclosed embodiments or illustrated examples.

### 1. Configuration of image forming system

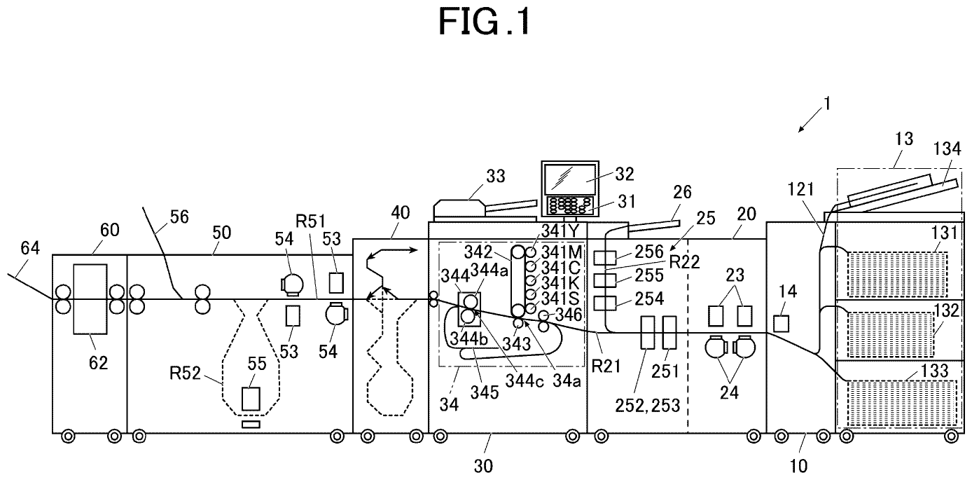

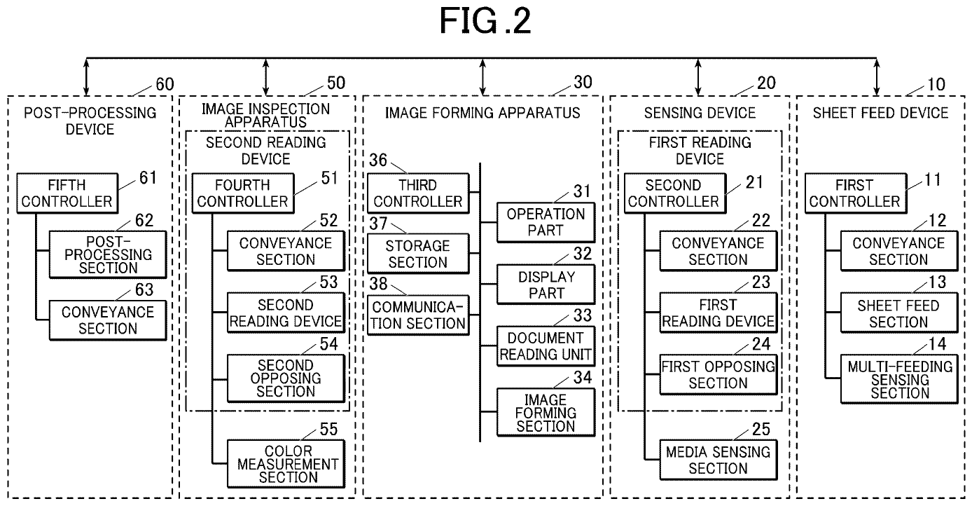

As shown in FIG. 1 and FIG. 2, an image forming system 1 according to the present embodiment includes a sheet feed device 10, a sensing device 20, an image forming apparatus 30, a relay conveyance section 40, an image inspection apparatus 50, and a post-processing device 60.

In the image forming system 1, the sheet feed device 10, the sensing device 20, the image forming apparatus 30, the relay conveyance section 40, the image inspection apparatus 50, and the post-processing device 60 are arranged in this order from the upstream side along a conveyance direction of sheets (recording media).

### 1-1. Configuration of Sheet Feed Device

The sheet feed device 10 includes a first controller 11, a conveyance section 12, a sheet feed section 13, a multi-feeding sensing section 14 (multi-feeding sensor), and the like.

The first controller 11 includes a central processing unit (CPU), a read only memory (ROM), a random access memory (RAM), and the like.

The CPU of the first controller 11 reads a program stored in the ROM, loads the program into the RAM, and collectively controls the components of the sheet feed device 10 in accordance with the program loaded into the RAM.

For example, in accordance with a print job, the first controller 11 conveys a sheet from one of sheet feed trays 131 to 133 or a manual sheet feed tray 134 of the sheet feed section 13 to the sensing device 20.

The conveyance section 12 includes a conveyance route 121 that connects the sheet feed section 13 to the sensing device 20 and conveys sheets.

The sheet feed section 13 includes the sheet feed trays 131 to 133 each configured to store sheets of a predetermined sheet type, size, and the like. For example, the sheet feed tray 131 stores sheets having a size larger than that of sheets stored in the sheet feed tray 132. The sheet feed tray 133 stores sheets having a greater sheet thickness than sheets stored in the sheet feed trays 131 and 132.

The sheet feed section 13 may include a sheet feed tray configured to feed roll paper while cutting the roll paper as appropriate.

The sheet feed section 13 is provided upstream of the sensing device 20 in the sheet conveyance direction, and functions as a supply section (supplier) configured to supply sheets.

The multi-feeding sensing section 14 is provided along the conveyance route 121 and senses multi-feeding of sheets conveyed from the sheet feed section 13. The “multi-feeding” means that two or more sheets are fed from the sheet feed section 13 in an overlapped state.

For example, the multi-feeding sensing section 14 transmits an ultrasonic wave to sheets conveyed from the sheet feed section 13, and senses multi-feeding of sheets based on the intensity of the ultrasonic wave having passed through the sheets.

When the multi-feeding sensing section 14 senses multi-feeding of sheets, the first controller 11 outputs the sensing result to a third controller 36 (hardware processor, described later).

### 1-2. Configuration of Sensing Device

The sensing device 20 is located downstream of the sheet feed device 10 and upstream of the image forming apparatus 30 in the sheet conveyance direction.

The sensing device 20 includes a second controller 21, a conveyance section 22, a first reading section(s) 23 (first reader), a first opposing section(s) 24, a media sensing section 25, a purge tray 26, and the like.

In the sensing device 20 of the present embodiment, two first reading sections 23 are provided above the conveyance route R21 in the vertical direction, along the conveyance route R21, which conveys sheets. The first reading section 23 reads the front surface, which is the upper surface in the vertical direction, of each sheet conveyed on the conveyance route R21.

The first opposing sections 24 are provided at positions opposing (facing) the first reading sections 23, below the conveyance route R21 in the vertical direction.

The sensing device 20 of the present embodiment includes a first reading device that is provided upstream of an image forming section 34 (image former, described later) in the sheet conveyance direction and that reads, with the first reading sections 23, sheets conveyed along the conveyance route R21 (first conveyance route). The first reading device includes the second controller 21, the conveyance section 22, the first reading sections 23, and the first opposing sections 24.

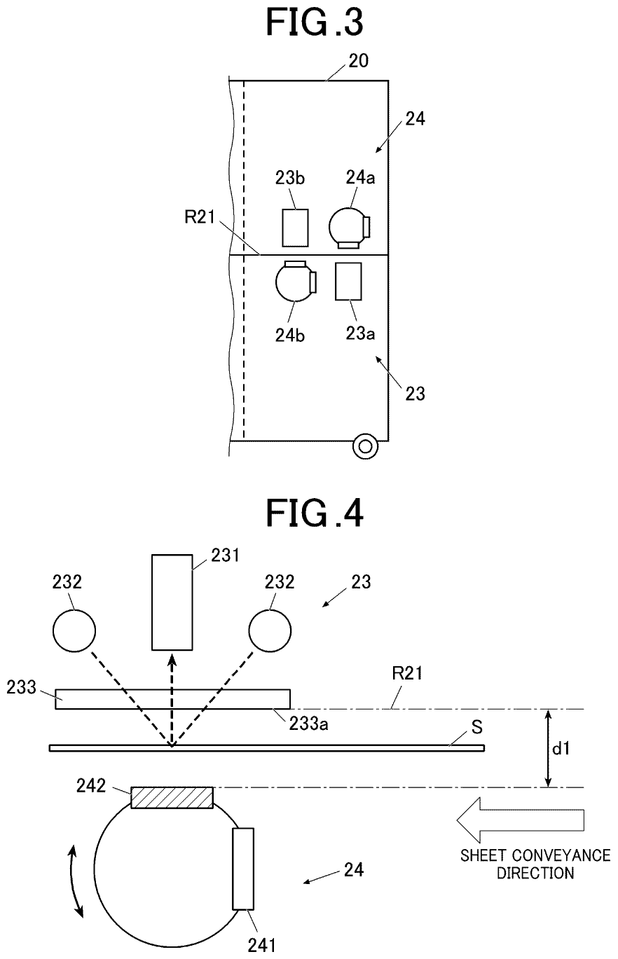

In the sensing device 20, the first reading sections 23 and the first opposing sections 24 may be configured as illustrated in FIG. 3. As shown in FIG. 3, one (first reading section 23a) of the two first reading sections 23 is provided vertically below the conveyance route R21 and reads the back surface of each sheet, which is the surface on the lower side of each sheet in the vertical direction. One (first opposing section 24a) of the two first opposing sections 24 is provided vertically above the conveyance route R21 at a position facing the first reading section 23a.

The other (first reading section 23b) of the two first reading sections 23 is provided vertically above the conveyance route R21 and reads the front surface of each sheet. The other (first opposing section 24b) of the two first opposing sections 24 is provided vertically below the conveyance route R21 at a position facing the first reading section 23b.

In the configuration shown in FIG. 3, the front surface and the back surface of each sheet can be read by the first reading sections 23a, 23b. Accordingly, whether a sheet is transparent can be sensed, and when the sheet is opaque, a difference in color tone between the front and back surfaces of the sheet, stains on the front and back surfaces, presence or absence of preprinting on the front and back surfaces, and the like can be sensed.

The second controller 21 includes a CPU, a ROM, a RAM, and the like.

The CPU of the second controller 21 reads a program stored in the ROM, loads the program into the RAM, and collectively controls the components of the sensing device 20 in accordance with the loaded program.

For example, the second controller 21 causes the first reading sections 23 to read a sheet conveyed from the sheet feed device 10 and outputs data of a first read image obtained to the third controller 36. Next, the second controller 21 causes the conveyance section 22 to convey, to the media sensing section 25, the sheet that has been read by the first reading sections 23. Next, the second controller 21 causes the media sensing section 25 to sense the sheet, and outputs an obtained physical property value of the sheet to the third controller 36. Next, the second controller 21 causes the conveyance section 22 to eject, to the purge tray 26, the sheet that has been sensed by the media sensing section 25.

Alternatively, the second controller 21 causes the conveyance section 22 to convey to the image forming apparatus 30, the sheet that has been read by the first reading sections 23, without causing the media sensing section 25 to sense the sheet.

The third controller 36 senses, based on the first read image, the sheet size, sheet color, sheet transparency, and the like before an image is formed by the image forming apparatus 30.

That is, the third controller 36 acquires information on the sheet size based on the first read image obtained by reading the sheet with the first reading sections 23. The third controller 36 functions as an acquisition section.

The third controller 36 determines parameters for respective processes in the image forming section 34 and the like based on the physical property value of the sheet, which is a sensing result obtained by the media sensing section 25.

The conveyance section 22 includes a plurality of roller pairs, and sequentially conveys sheets conveyed from the sheet feed device 10 to the position between the first reading sections 23 and the first opposing sections 24 and then to the media sensing section 25. Next, the conveyance section 22 conveys to the purge tray 26, the sheet that has been read by the first reading sections 23 and sensed by the media sensing section 25.

Alternatively, the conveyance section 22 conveys the sheet conveyed from the sheet feed device 10 to the position between the first reading sections 23 and the first opposing sections 24. Next, the conveyance section 22 conveys to the image forming apparatus 30, the sheet that has been read by the first reading sections 23, without causing the media sensing section 25 to sense the sheet.

The conveyance section 22 includes the conveyance route R21 that passes between the first reading sections 23 and the first opposing sections 24 and is connected to the image forming apparatus 30, and a sensing route R22 that branches from the conveyance route R21 and is connected to the purge tray 26.

As illustrated in FIG. 4, each first reading section 23 includes a line image sensor 231, illumination sections 232, a transmissive member 233, and the like. In the first reading section 23 of the present embodiment, one illumination section 232 is provided on each of the upstream side and the downstream side of the line image sensor 231 in the sheet conveyance direction.

In the line image sensor 231, a plurality of imaging elements each configured to perform photoelectric conversion for one pixel are arranged in a one-dimensional array in the width direction of sheets. The sheet width direction is a direction orthogonal to the sheet conveyance direction. The imaging elements are, for example, charge coupled devices (CCDs).

Each illumination section 232 irradiates a sheet with light so that the sheet can be read properly. Specifically, the illumination section 232 illuminates a reading area of the line image sensor 231 by causing light to be incident on the reading area at a predetermined angle (e.g., 45 degrees). The line image sensor 231 performs reading at a light-receiving angle of 0 degrees with respect to the reading area. The light-receiving angle of 0 degrees with respect to the reading area refers to an orientation for sensing reflected light in a direction perpendicular to the reading area.

The illumination section 232 includes, for example, an LED (light-emitting diode) and a diffusion member that uniformly spreads emitted light over the reading area.

The transmissive member 233 is, for example, a glass plate.

As shown in FIG. 4, the transmissive member 233 isolates and protects the line image sensor 231 from a sheet S conveyed along the conveyance route R21.

The first reading section 23 may include a contact image sensor (CIS) in which a line image sensor and an illumination section are integrated, or may include a two-dimensional area sensor and an illumination section, or the like.

Each first opposing section 24 includes background members 241, 242 that serve as the background of a sheet image when the sheet is read by the first reading section 23.

The background members 241 and 242 have different densities (colors); for example, the background member 241 is white, and the background member 242 is black.

The first opposing section 24 can be rotated by a driving source (not shown) to switch the background member used during sheet reading between the background member 241 and the background member 242.

The readable area of the first reading section 23 is an area in which a first read image includes at least an outline of the sheet and an area of the background member in the vicinity.

The media sensing section 25 senses values (physical property values) relating to multiple types of physical properties of sheets, including thickness, basis weight, moisture content, stiffness, surface property, electrical resistance, and the like. Each physical property value may be information that is convertible (or transformable) into a physical property.

The media sensing section 25 includes a sheet thickness sensor 251, a basis weight sensor 252, a moisture content sensor 253, a stiffness sensor 254, a surface property sensor 255, and a resistance sensor 256.

The sheet thickness sensor 251, the basis weight sensor 252, and the moisture content sensor 253 are provided on the conveyance route R21.

The stiffness sensor 254, the surface property sensor 255, and the resistance sensor 256 are provided on the sensing route R22.

The sheet thickness sensor 251 measures the sheet thickness by sensing a shaft position of a driven roller that is displaced in accordance with the sheet thickness when the sheet is conveyed by a nip of a conveyance roller pair. The media sensing section 25 outputs the sheet thickness as a physical property value to the second controller 21.

The basis weight sensor 252 and the moisture content sensor 253 are provided side by side at different positions in the sheet width direction at the same position in the sheet conveyance direction.

The basis weight sensor 252 includes a light emitting section and a light receiving section and measures the sheet basis weight based on the amount of attenuation of light that passes through the sheet. The media sensing section 25 outputs the basis weight as a physical property value to the second controller 21.

The moisture content sensor 253 includes a first light emitting section and a second light emitting section configured to emit light having wavelengths with different absorptions by moisture in the sheet, and a light receiving section. The moisture content sensor 253 senses the moisture content of the sheet based on a ratio of the received amount of light emitted from the first light emitting section and reflected by the sheet and the received amount of light emitted from the second light emitting section and reflected by the sheet. The media sensing section 25 outputs the moisture content as a physical property value to the second controller 21.

The stiffness sensor 254 senses a physical property corresponding to the stiffness of the sheet. For example, when a sheet is conveyed along a curved conveyance route, the stiffness sensor 254 mechanically measures the force with which the sheet presses one of outer guide plates constituting the conveyance route, or the amount of displacement of the outer guide plate, on the curved conveyance route. The media sensing section 25 outputs, to the second controller 21, the stiffness as a physical property value based on the pressing force exerted by the sheet or the displacement amount.

The surface property sensor 255 is, for example, a reflective optical sensor, and senses the surface property of the sheet based on absolute values and a ratio of intensities of specular reflection light and scattered reflection light. The surface property of the sheet includes the presence or absence of a coating on the surface of the sheet, the type of coating when the coating is present, surface roughness, smoothness, and the like. The media sensing section 25 outputs the surface property as a physical property value to the second controller 21.

The resistance sensor 256, for example, applies a high voltage between the front and back surfaces of a stopped sheet, and senses the electrical resistance (volume electrical resistance) of the sheet based on the value of a current that flows. The media sensing section 25 outputs, to the second controller 21, the electrical resistance as a physical property value.

### 1-3. Configuration of Image Forming Apparatus

The image forming apparatus 30 is located downstream of the sensing device 20 in the sheet conveyance direction and upstream of the relay conveyance section 40 in the sheet conveyance direction.

The image forming apparatus 30 forms a color image by an electrophotographic method based on image data obtained by reading an image from a document, or job image data included in a print job received from an external apparatus (not shown). Next, the image forming apparatus 30 conveys the sheet on which an image has been formed to the relay conveyance section 40.

As illustrated in FIG. 1 and FIG. 2, the image forming apparatus 30 includes an operation part 31, a display part 32, a document reading unit 33, an image forming section 34, a third controller 36, a storage section 37, and a communication section 38.

The operation part 31 includes a touch screen formed so as to cover the display screen of the display part 32, and various operation buttons such as numeric buttons and a start button.

The operation part 31 outputs, to the third controller 36, an operation signal based on a user operation.

The display part 32 includes an LCD (Liquid Crystal Display) or the like.

The display part 32 displays various screens in accordance with display signals input from the third controller 36.

The document reading unit 33 includes an automatic document feeder (ADF), a scanner, and the like.

The document reading unit 33 outputs, to the third controller 36, image data obtained by reading an image of a document.

The image forming section 34 forms, using an intermediate transfer method, an image on a sheet conveyed from the sensing device 20, based on the image data that has been subjected to image processing.

The image forming section 34 includes photosensitive drums 341Y, 341M, 341C, 341K, and 341S corresponding to respective colors of yellow (Y), magenta (M), cyan (C), black (K), and a spot color(S). The spot color is, for example, white.

The image forming section 34 further includes an intermediate transfer belt 342, a secondary transfer roller 343, a fixing section 344, a reversing route 345, a registration section 346, and the like.

The image forming section 34 uniformly charges the photosensitive drum 341Y and then performs scanning exposure with a laser beam based on yellow image data to form an electrostatic latent image on the photosensitive drum 341Y. Next, the image forming section 34 causes yellow toner to adhere to the electrostatic latent image on the photosensitive drum 341Y to develop the latent image.

The photosensitive drums 341M, 341C, 341K, and 341S are the same as the photosensitive drum 341Y except that the colors handled differ, and thus description thereof is omitted.

The image forming section 34 sequentially transfers toner images of respective colors formed on the photosensitive drums 341Y, 341M, 341C, 341K, and 341S onto the rotating intermediate transfer belt 342 (primary transfer). That is, the image forming section 34 forms, on the intermediate transfer belt 342, a color toner image in which toner images of five colors are superimposed.

The image forming section 34 collectively transfers the color toner image on the intermediate transfer belt 342 onto a sheet by the secondary transfer roller 343 (secondary transfer). The secondary transfer roller 343 functions as a transfer section that transfers, to a sheet, the toner image carried on the surface of the intermediate transfer belt 342.

A transfer nip 34a is formed by the intermediate transfer belt 342 and the secondary transfer roller 343.

The fixing section 344 includes a heating roller 344a that heats a sheet onto which a color toner image has been transferred, a pressure roller 344b that presses the sheet, and the like.

The fixing section 344 fixes the color toner image to the sheet by heating and pressing at a fixing nip 344c formed by the heating roller 344a and the pressure roller 344b.

In the case of single-sided printing in which an image is formed on one side of a sheet in the image forming apparatus 30, the third controller 36 conveys the sheet from the fixing section 344 to the relay conveyance section 40.

On the other hand, in the case of double-sided printing in which images are formed on both sides of a sheet, the third controller 36 conveys the sheet from the fixing section 344 to the reversing route 345 to reverse the sheet. Next, the third controller 36 feeds the sheet again to a position on the upstream side of the registration section 346 in the sheet conveyance direction.

The registration section 346 includes registration rollers and conveys a sheet to the transfer nip 34a.

The registration section 346 corrects skew of a sheet conveyed from the sensing device 20 and adjusts a conveyance timing of the sheet.

The image forming section 34 may be configured to form toner images in four colors: yellow (Y), magenta (M), cyan (C), and black (K).

The third controller 36 includes a CPU, a RAM, a ROM, and the like.

The CPU of the third controller 36 reads various process programs stored in the ROM and loads the programs into the RAM. The third controller 36 comprehensively controls the operation of the image forming apparatus 30 by executing various programs loaded into the RAM.

The storage section 37 is a nonvolatile storage device, such as a hard disk drive (HDD) or a semiconductor memory, that stores various data such as programs and image data.

The storage section 37 stores data such as program data and various setting data so as to be readable and writable by the third controller 36.

The communication section 38 includes, for example, a communication control card such as a local area network (LAN) card.

The communication section 38 transmits and receives various types of data to and from an external apparatus (e.g., a personal computer) connected to a communication network such as a LAN or a wide area network (WAN).

The relay conveyance section 40 is located downstream of the image forming apparatus 30 in the sheet conveyance direction and upstream of the image inspection apparatus 50 in the sheet conveyance direction.

The relay conveyance section 40 can, as appropriate, perform curl correction, sheet reversing, and the like on a sheet conveyed from the image forming apparatus 30. The sheet reversing is processing for reversing the leading and trailing ends of the sheet in the sheet conveyance direction.

### 1-4. Configuration of Image Inspection Apparatus

The image inspection apparatus 50 is located downstream of the relay conveyance section 40 and upstream of the post-processing device 60 in the sheet conveyance direction.

The image inspection apparatus 50 includes a fourth controller 51, a conveyance section 52, a second reading section(s) 53 (second reader), a second opposing section(s) 54, a color measurement section 55, a purge tray 56, and the like.

The fourth controller 51 includes a CPU, a ROM, a RAM, and the like.

The CPU of the fourth controller 51 reads a program stored in the ROM, loads the program into the RAM, and collectively controls the components of the image inspection apparatus 50 in accordance with the loaded program.

For example, the fourth controller 51 causes the second reading section 53 to read a sheet conveyed from the relay conveyance section 40, and outputs data of the obtained second read image to the third controller 36. Next, the fourth controller 51, as appropriate, conveys, by the conveyance section 52, the sheet read by the second reading section 53 to the color measurement section 55. Next, the fourth controller 51 causes the color measurement section 55 to perform color measurement on the sheet, and outputs the obtained color measurement result to the third controller 36. Next, the fourth controller 51 ejects, by the conveyance section 52, the sheet on which color measurement has been performed by the color measurement section 55 to the post-processing device 60 or the purge tray 56. When color measurement of the sheet is not performed by the color measurement section 55, the fourth controller 51 ejects, by the conveyance section 52, the sheet read by the second reading section 53 to the post-processing device 60 or the purge tray 56.

Based on the second read image, the third controller 36 performs adjustment of an image position on a sheet on which an image has been formed by the image forming apparatus 30, evaluation of an image condition on the sheet, and the like. The evaluation of the image condition on the sheet includes sensing whether an abnormality (e.g., adhesion of dirt, erroneous printing, etc.) is present by comparison between the second read image and a reference image.

That is, the third controller 36 senses whether an abnormality is present in the second read image obtained by the second reading section 53 reading the sheet. The third controller 36 functions as an image inspection section.

When an abnormality is sensed in the second read image by the third controller 36, the fourth controller 51 causes the conveyance section 52 to eject the sheet in which the abnormality is sensed to the purge tray 56. On the other hand, the fourth controller 51 causes the conveyance section 52 to convey to the post-processing device 60, the sheet where no abnormality is sensed in the second read image.

Based on a color measurement result obtained by the color measurement section 55, the third controller 36 compares a gradation value measured by the color measurement section 55 with a gradation value specified in original image data of an image formed on the sheet. Next, based on comparison of these, the third controller 36 creates a color profile used to correct hue during image formation by the image forming section 34.

The conveyance section 52 includes a conveyance route R51 that passes between the second reading section 53 and the second opposing section 54 and is connected to the post-processing device 60, and a color measurement route R52 that branches from the conveyance route R51 and merges back into the conveyance route R51.

The conveyance section 52 includes a plurality of roller pairs and conveys, to the second reading section 53, a sheet conveyed from the relay conveyance section 40. Next, the conveyance section 52 conveys the sheet read by the second reading section 53 to the color measurement section 55 via the color measurement route R52. Next, the conveyance section 52 ejects a sheet that has undergone color measurement by the color measurement section 55 to the post-processing device 60 or the purge tray 56. Alternatively, the conveyance section 52 conveys the sheet read by the second reading section 53 to the post-processing device 60 or the purge tray 56 not via the color measurement route R52.

In the image inspection apparatus 50, two second reading sections 53 and two second opposing sections 54 are provided along the conveyance route R51 along which a sheet is conveyed, with the conveyance route R51 interposed therebetween.

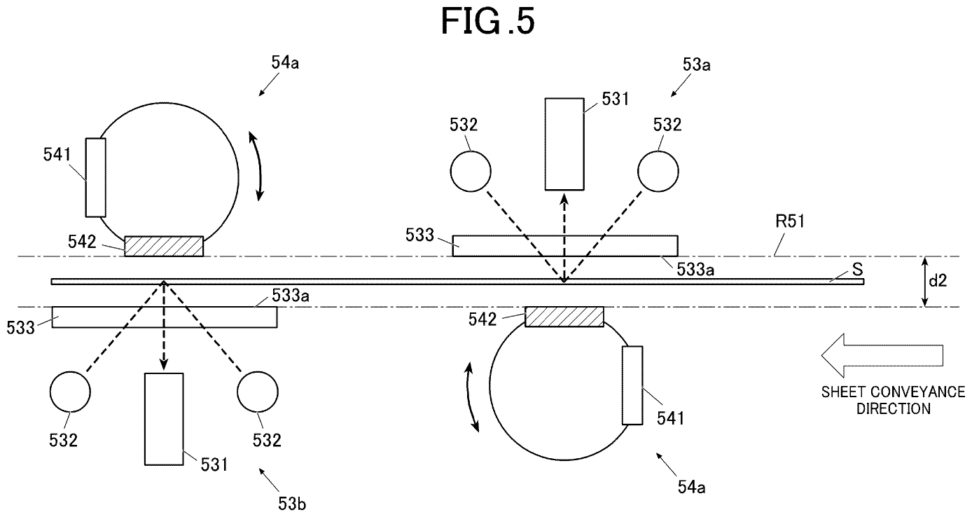

Specifically, as shown in FIG. 5, one (second reading section 53a) of the two second reading sections 53 is provided vertically above the conveyance route R51 and reads the front surface of the sheet. One (second opposing section 54a) of the two second opposing sections 54 is provided vertically below the conveyance route R51 at a position opposing the second reading section 53a.

The other (second reading section 53b) of the two second reading sections 53 is provided vertically below the conveyance route R51 and reads the back surface of the sheet. The other (second opposing section 54b) of the two second opposing sections 54 is provided vertically above the conveyance route R51 at a position opposing the second reading section 53b.

The second reading section 53 has a configuration similar to that of the first reading section 23 and includes a line image sensor 531, an illumination section 532, a transmissive member 533, and the like.

The second opposing section 54 has a configuration similar to that of the first opposing section 24 and includes background members 541 and 542, and the like, which serve as the background of a sheet image when the sheet is read by the second reading section 53.

The color measurement section 55 is provided on the color measurement route R52 downstream of the second reading section 53 in the sheet conveyance direction.

The color measurement section 55 performs color measurement on an image on a sheet conveyed along the color measurement route R52. The color measurement result is output to the third controller 36 via the fourth controller 51.

The color measurement section 55 is capable of accurately measuring the colors of color patches formed on a sheet by the image forming apparatus 30.

The image inspection apparatus 50 according to the present embodiment includes a second reading device provided downstream of the image forming section 34 in the sheet conveyance direction and configured to read a sheet conveyed along the conveyance route R51 (second conveyance route) with the second reading section 53. The second reading device includes the fourth controller 51, the conveyance section 52, the second reading section 53, and the second opposing section 54.

### 1-5. Configuration of Post-Processing Device

The post-processing device 60 is located downstream of the image inspection apparatus 50 in the sheet conveyance direction and performs post-processing on a sheet conveyed from the image inspection apparatus 50.

The post-processing device 60 includes a fifth controller 61, a post-processing section 62, a conveyance section 63, and a sheet ejection tray 64.

The fifth controller 61 includes a CPU, a RAM, a ROM, and the like.

The CPU of the fifth controller 61 reads various process programs stored in the ROM and loads the programs into the RAM. The fifth controller 61 comprehensively controls operation of the post-processing device 60 by executing various programs loaded into the RAM.

The post-processing section 62 performs post-processing on a sheet conveyed from the image inspection apparatus 50. The post-processing includes, for example, cutting, fold-line processing, perforation processing, scoring (creasing), foil stamping, varnish processing, and various types of bookbinding.

The conveyance section 63 includes a plurality of roller pairs and conveys a sheet received from the image inspection apparatus 50 to the post-processing section 62. Next, the conveyance section 63 ejects a sheet that has been subjected to the post-processing by the post-processing section 62 to the sheet ejection tray 64.

In the present embodiment, the third controller 36 of the image forming apparatus 30 centrally controls the entire image forming system 1; however, the present disclosure is not limited thereto. The first controller 11 of the sheet feed device 10, the second controller 21 of the sensing device 20, the fourth controller 51 of the image inspection apparatus 50, or the fifth controller 61 of the post-processing device 60 may be configured to centrally control the entire image forming system 1.

### 2. DISTANCE BETWEEN READING SECTION AND OPPOSING SECTION

Next, a first distance d1 (see FIG. 4) that is a distance between the first reading section 23 and the first opposing section 24 and a second distance d2 (see FIG. 5) that is a distance between the second reading section 53 and the second opposing section 54 in the present embodiment will be described.

The first distance d1 is a distance between a first glass surface 233a, which is the surface of the transmissive member 233 on the conveyance route R21 side in the vertical direction, and a background member (background member 242 in FIG. 4) facing the first reading section 23.

The background member facing the first reading section 23 functions as a first restricting member that restricts the passable area for the sheet in the vertical direction at the conveyance route R21.

To accurately read a sheet with the first reading section 23, it is necessary to accurately control the passage position of the sheet on the conveyance route R21. For this purpose, it is desirable that the first distance d1 be set as small as possible.

However, during execution of job printing or the like in the image forming system 1, sheets may be fed from any tray of the sheet feed section 13 in a multi-fed state in which two or more sheets are conveyed in an overlapped manner.

When sheets in the multi-fed state are conveyed in the image forming system 1, a passing-sheet jam may occur at a location where the conveyance route is narrow, a location where the conveyance route is curved, or the like. When sheets in the multi-fed state enter the image forming apparatus 30, a passing-sheet jam may occur in the image forming apparatus 30. Depending on the location where the passing-sheet jam has occurred, recovery of the image forming apparatus 30 may be difficult, or a malfunction may occur in an image forming mechanism or the like.

Therefore, when multi-feeding of sheets is sensed by the multi-feeding sensing section 14, the third controller 36 controls the sheet feed device 10 and the sensing device 20 so as to convey, along the sensing route R22, sheets in the multi-fed state conveyed from the sheet feed device 10, and to eject the sheets to the purge tray 26.

That is, the third controller 36 ejects the sheet via the sensing route R22 (ejection route) provided between the first reading device and the image forming section 34 in the sheet conveyance direction. The third controller 36 functions as an ejection section.

At this time, sheets in the multi-fed state are conveyed between the first reading section 23 and the first opposing section 24; however, if the first distance d1 is not long enough to allow conveyance of the sheets in the multi-fed state, a passing-sheet jam occurs between the first reading section 23 and the first opposing section 24.

For this reason, in the present embodiment, the first distance d1 is set to a value that allows sheets in the multi-fed state to be conveyed between the first reading section 23 and the first opposing section 24. The sheets are the thickest sheets among sheets on which an image is to be formed by the image forming apparatus 30.

Thus, even when sheets in the multi-fed state are fed from the sheet feed section 13, the sheets in the multi-fed state can be conveyed sequentially to the space between the first reading section 23 and the first opposing section 24 and then along the sensing route R22, and can be ejected to the purge tray 26 before the sheets enter the image forming apparatus 30. Therefore, when sheets in the multi-fed state are fed, the image forming system 1 can be safely stopped.

The second distance d2 is a distance between a second glass surface 533a, which is the surface of the transmissive member 533 on the conveyance route R51 side in the vertical direction, and a background member (background member 542 in FIG. 5) that faces the second reading section 53.

The background member facing the second reading section 53 functions as a second restricting member that restricts the passable area for the sheet in the vertical direction at the conveyance route R51.

A second read image, which is a read result obtained by the second reading section 53, is used to evaluate the state of an image formed on a sheet. Therefore, to accurately read a sheet with the second reading section 53, it is necessary to accurately control the passage position of the sheet on the conveyance route R51. For this purpose, it is desirable to set the second distance d2 as small as possible.

In the present embodiment, the second distance d2 is set to a size that allows the thickest sheet among sheets on which image forming is performed by the image forming apparatus 30 to stably pass, and that does not allow the sheets in the multi-fed state to be conveyed.

That is, the first distance d1, which is long enough to convey sheets in the multi-fed state, is longer than the second distance d2.

### 3. MODIFICATION EXAMPLES

Next, modification examples of the above-described embodiment will be described. In the modification examples, the same reference numerals denote components that are the same as those in the above-described embodiment, and description thereof is omitted.

### 3-1. First Modification Example

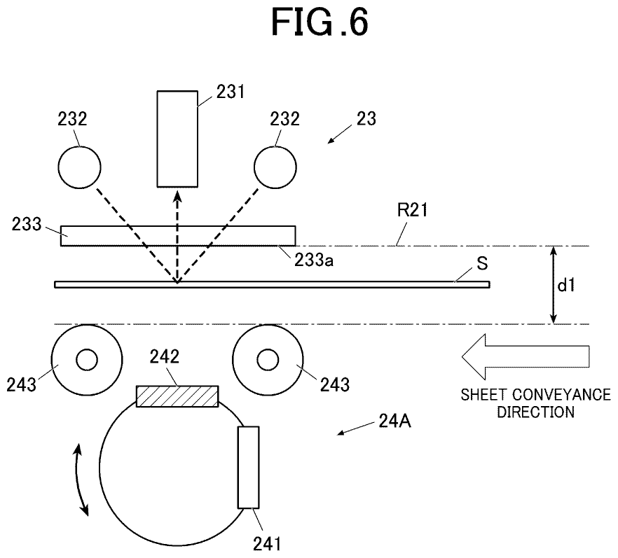

FIG. 6 illustrates the configuration of a first opposing section 24A included in the sensing device 20 according to a first modification example.

The first opposing section 24A of the first modification example includes control members 243, such as rollers, provided upstream and downstream, in the sheet conveyance direction, of a background member (background member 242 in FIG. 6) facing the first reading section 23, within a predetermined area from the background member. In other words, the first opposing section 24A of the first modification example includes the control members 243 at positions close to the upstream side and the downstream side, in the sheet conveyance direction, of the background member (background member 242 in FIG. 6) facing the first reading section 23.

The upper end of the control members 243 is positioned above, in the vertical direction, the background member (background member 242 in FIG. 6) facing the first reading section 23.

Thus, a sheet conveyed on the conveyance route R21 passes over the control members 243. Accordingly, it is possible to prevent the sheet S conveyed along the conveyance route R21 from colliding with the background member (background member 242 in FIG. 6) facing the first reading section 23.

The control members 243 are members that contact a sheet conveyed along the conveyance route R21 and control the position (height) of the sheet in the vertical direction.

In the sensing device 20 according to the first modification example, although no member is provided at a position facing the first reading section 23 to restrict a sheet conveyed along the conveyance route R21, the passing position of the sheet can be controlled by the control members 243.

In the first modification example, a first distance d1 is a distance in the vertical direction between the first glass surface 233a and the upper end of the control members 243.

The control members 243 function as the first restricting member that restricts the passable area for the sheet in the vertical direction at the conveyance route R21.

The second opposing section 54 included in the image inspection apparatus 50 of the first modification example may have the same configuration as the first opposing section 24A and may include control members such as rollers that control the position of a sheet in the vertical direction. In this case, a second distance d2 in the first modification example is a distance in the vertical direction between the second glass surface 533a and the upper end of the control members. The control members function as the second restricting member that restricts the passable area for the sheet in the vertical direction at the conveyance route R51.

### 3-2. Second Modification Example

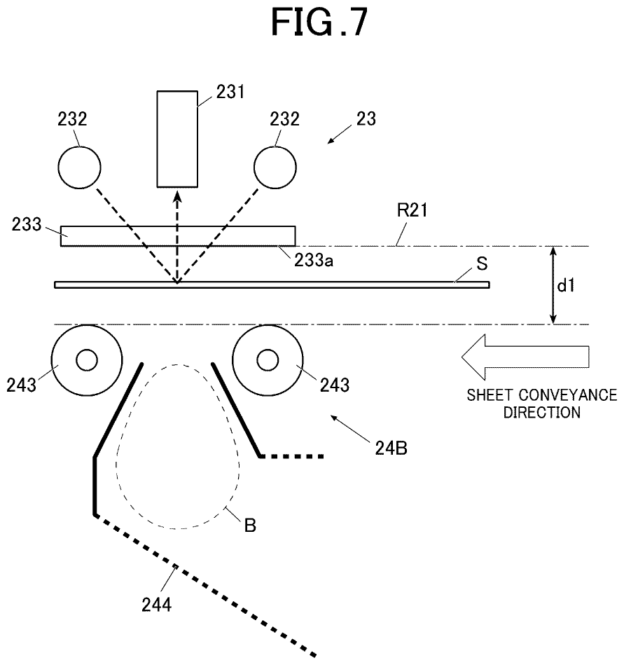

FIG. 7 illustrates the configuration of a first opposing section 24B provided in the sensing device 20 of a second modification example.

The first opposing section 24B of the second modification example includes control members 243 similar to those of the first opposing section 24A of the first modification example.

The first opposing section 24B of the second modification example, instead of including the background member 241 or 242, includes a background space B having a depth sufficient to be used as a black background at a position facing the first reading section 23 with the conveyance route R21 therebetween.

The first opposing section 24B of the second modification example may further include a black light absorbing member in the background space B.

The first opposing section 24B of the second modification example may further include an illumination section (not shown) and a background member 244 that is irradiated with light from the illumination section and functions as a white background. The background member 244 is formed of a white diffuser or a reflective material.

In the second modification example, as in the first modification example, the first distance d1 is a distance in the vertical direction between the first glass surface 233a and the upper end of the control members 243.

The second opposing section 54 included in the image inspection apparatus 50 according to the second modification example may have the same configuration as the first opposing section 24B and may include control members that control the position of a sheet in the vertical direction, such as rollers, and a background space. In this case, the second distance d2 of the second modification example is a distance in the vertical direction between the second glass surface 533a and the upper end of the control members.

### 4. ADVANTAGEOUS EFFECTS

As described above, the image forming system 1 according to the present embodiment includes the image forming section 34 configured to form an image on a recording medium (sheet).

The image forming system 1 according to the present embodiment includes the first reading device provided upstream of the image forming section 34 in the conveyance direction of the recording medium, the first reading device being configured to read the recording medium conveyed along the first conveyance route (conveyance route R21) with the first reading section 23.

The image forming system 1 according to the present embodiment includes the second reading device provided downstream of the image forming section 34 in the conveyance direction of the recording medium, the second reading device being configured to read the recording medium conveyed along the second conveyance route (conveyance route R51) with the second reading section 53.

The first distance d1 in the first reading device is longer than the second distance d2 in the second reading device. The first distance d1 is the distance between the first reading section 23 and the first restricting member that restricts the passable area for the recording medium at the first conveyance route. The second distance d2 is the distance between the second reading section 53 and the second restricting member that restricts the passable area for the recording medium at the second conveyance route.

Accordingly, the first distance d1 is set to a size that allows sheets in the multi-fed state to be conveyed between the first reading section 23 and the first opposing section 24. Further, the second distance d2 is set to a size that allows a sheet to stably pass and that does not allow sheets in the multi-fed state to be conveyed.

Thus, occurrence of a jam at the time when multi-fed recording media pass between the first reading section 23 and the first opposing section 24 can be suppressed. In addition, sheets can be read with high accuracy by the second reading section 53.

In the image forming system 1 according to the present embodiment, the first reading section 23 has the first glass surface 233a on the first conveyance route (conveyance route R21) side. The second reading section 53 has the second glass surface 533a on the second conveyance route (conveyance route R51) side.

The first distance d1 is the distance between the first glass surface 233a and the first restricting member.

The second distance d2 is the distance between the second glass surface 533a and the second restricting member.

Therefore, the first glass surface 233a can isolate and protect the line image sensor 231 from a sheet conveyed along the conveyance route R21. The second glass surface 533a can isolate and protect the line image sensor 531 from a sheet conveyed along the conveyance route R51.

The image forming system 1 according to the present embodiment includes the acquisition section (third controller 36) configured to acquire information on the size of the recording medium, based on the first read image obtained by the first reading section 23 reading the recording medium (sheet).

Thus, the size of the sheet can be sensed before image formation.

In the image forming system 1 according to the present embodiment, the first reading device is included in the sensing device 20 that senses information on the physical properties of the recording medium (sheet).

In the image forming system 1 according to the present embodiment, the second reading section 53 reads the recording medium (sheet) on which an image has been formed by the image forming section 34.

The image forming system 1 according to the present embodiment includes the image inspection section (third controller 36) configured to sense presence or absence of an abnormality in the second read image obtained by the second reading section 53 reading the recording medium.

Accordingly, the second reading section 53 can accurately read the sheet after image formation at the second distance d2 that is shorter than the first distance d1. The image inspection section can accurately sense the presence or absence of an abnormality in the second read image based on the second read image that has been accurately obtained.

The image forming system 1 according to the present embodiment includes the supplier (sheet feed section 13) that is provided upstream of the first reading device in the conveyance direction of the recording medium (sheet) and supplies the recording medium.

The image forming system 1 according to the present embodiment includes the sheet ejection section (third controller 36) configured to eject the recording medium through the ejection route (sensing route R22) provided between the first reading device and the image forming section 34 in the conveyance direction of the recording medium.

The image forming system 1 according to the present embodiment includes the multi-feeding sensing section 14 configured to sense the multi-feeding of recording media supplied from the supplier (sheet feed section 13).

In the image forming system 1 according to the present embodiment, the ejection section ejects recording media through the ejection route when multi-feeding of the recording media is sensed by the multi-feeding sensing section 14.

Accordingly, it is possible to suppress occurrence of a passing-sheet jam in the image forming apparatus 30 that would otherwise be caused by sheets conveyed in the multi-fed state entering the image forming apparatus 30. It is possible to suppress occurrence of a malfunction in an image forming mechanism or the like due to occurrence of a passing-sheet jam in the image forming apparatus 30 that would otherwise be caused by sheets in the multi-fed state.

In the image forming system 1 according to the present embodiment, when multi-feeding of recording media (sheets) is sensed by the multi-feeding sensing section 14, the ejection section (third controller 36) ejects the recording media via the first reading device and the ejection route (sensing route R22).

Accordingly, the sheets in the multi-fed state can be ejected to the outside without causing a passing-sheet jam in the image forming system 1.

In the image forming system 1 according to the present embodiment, the first restricting member is the background member that serves as the background in the first read image obtained by the first reading section 23 reading a recording medium (sheet).

The second restricting member is the background member that serves as the background in the second read image obtained by the second reading section 53 reading the recording medium.

In the image forming system 1 according to the present embodiment, the first restricting member is the control members 243 that restrict the passable area for the recording medium (sheet) in the vertical direction at the first conveyance route (conveyance route R21).

The second restricting member is the control members that restrict the passable area for the recording medium in the vertical direction at the second conveyance route (conveyance route R51).

Although one or more embodiments according to the present disclosure have been described in detail above, the present disclosure is not limited to the above-described embodiments, and various modification examples can be made without departing from the scope of the present disclosure.

For example, the image forming system 1 may be configured to transmit and receive information for interoperation to and from a print controller (not illustrated) configured to perform print job generation, print management, and the like, another image forming system (not illustrated), a business management system, and/or the like.

In the present embodiment, the third controller 36 of the image forming apparatus 30 centrally controls the entire image forming system 1; however, the present disclosure is not limited thereto. A control device may be provided separately, and a controller of the control device may centrally control the entirety of the image forming system 1.

In addition, the detailed configuration and detailed operation of each device constituting the image forming system 1 may be changed as appropriate without departing from the scope of the present disclosure.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming system comprising:
an image former configured to form an image on a recording medium;
a first reading device provided upstream of the image former in a conveyance direction of the recording medium and configured to read, with a first reader, the recording medium conveyed along a first conveyance route; and
a second reading device provided downstream of the image former in the conveyance direction of the recording medium and configured to read, with a second reader, the recording medium conveyed along a second conveyance route,
wherein a first distance that is a distance between the first reader in the first reading device and a first restricting member that restricts a passable area for the recording medium at the first conveyance route is longer than a second distance that is a distance between the second reader in the second reading device and a second restricting member that restricts a passable area for the recording medium at the second conveyance route.

2. The image forming system according to claim 1,
wherein the first reader has a first glass surface on a side where the first conveyance route is provided,
wherein the second reader has a second glass surface on a side where the second conveyance route is provided,
wherein the first distance is a distance between the first glass surface and the first restricting member, and
wherein the second distance is a distance between the second glass surface and the second restricting member.

3. The image forming system according to claim 1, further comprising a hardware processor configured to acquire information on a size of the recording medium based on a first read image obtained by the first reader reading the recording medium.

4. The image forming system according to claim 1, wherein the first reading device is included in a sensing device configured to sense information on a physical property of the recording medium.

5. The image forming system according to claim 1,
wherein the second reader reads the recording medium on which an image has been formed by the image former, and
wherein the image forming system further comprises a hardware processor configured to sense presence or absence of an abnormality in a second read image obtained by the second reader reading the recording medium.

6. The image forming system according to claim 1, further comprising:
a supplier provided upstream of the first reading device in the conveyance direction of the recording medium and configured to supply the recording medium, and
a hardware processor configured to eject the recording medium via an ejection route provided between the first reading device and the image former in the conveyance direction of the recording medium.

7. The image forming system according to claim 6, further comprising a multi-feeding sensor configured to sense multi-feeding of recording media, each of which is the recording medium supplied from the suppler,
wherein in response to the multi-feeding sensor sensing the multi-feeding of the recording media, the hardware processor ejects the recording media via the ejection route.

8. The image forming system according to claim 7, wherein in response to the multi-feeding sensor sensing the multi-feeding of the recording media, the hardware processor ejects the recording media via the first reading device and the ejection route.

9. The image forming system according to claim 1,
wherein the first restricting member is a background member that serves as a background in a first read image obtained by the first reader reading the recording medium, and
wherein the second restricting member is a background member that serves as a background in a second read image obtained by the second reader reading the recording medium.

10. The image forming system according to claim 1,
wherein the first restricting member is a control member configured to restrict a passable area for the recording medium in a vertical direction at the first conveyance route, and
wherein the second restricting member is a control member configured to restrict a passable area for the recording medium in the vertical direction at the second conveyance route.
